(19) United States
(12) Patent Application Publication
(10) Pub. No.: US 2025/0077250 A1
(43) Pub. Date: Mar. 6, 2025

(54) SITE RELIABILITY ENGINEERING MATURITY ASSESSMENT AND WORKLOAD MANAGEMENT

(71) Applicant: International Business Machines Corporation, Armonk, NY (US)

(72) Inventors: Abhishek Jain, Baraut (IN); Adinarayana Haridas, Hyderabad (IN); Manjunath Sangappan, Bengaluru (IN)

(73) Assignee: International Business Machines Corporation, Armonk, NY (US)

(21) Appl. No.: 18/240,040

(22) Filed: Aug. 30, 2023

(51) Int. Cl. G06F 9/455

(52) U.S. Cl. CPC G06F 9/45558; G06F 2009/4557; G06F 2009/45595

(57) ABSTRACT

An embodiment defines, by a site reliability engineering maturity engine, a plurality of tenets, a tenet in the plurality of tenets representing a principle of site reliability engineering. The embodiment generates, by the site reliability engineering maturity engine for the plurality of tenets, a first site reliability engineering maturity assessment for a first hybrid cloud component, a second site reliability engineering maturity assessment for a second hybrid cloud component, and a third site reliability engineering maturity assessment for an application. The embodiment determines, by the site reliability engineering maturity engine, a workload placement for the application based on the first, second, and third site reliability engineering maturity assessments. The embodiment initiates, by the site reliability engineering maturity engine, a workload migration for the application based on the workload placement.

### BACKGROUND

The present invention relates generally to site reliability engineering. More particularly, the present invention relates to a method, system, and computer program for site reliability engineering maturity assessment and workload management.

Site reliability engineering (SRE) is a discipline that incorporates aspects of software engineering and applies them to infrastructure and operations problems. Site reliability engineering is based on the principles of reliability, scalability, and performance. As part of their responsibilities, site reliability engineers often undertake assessments to evaluate the maturity of a client's operations. This maturity assessment may serve as a comprehensive framework to guide and benchmark a client's practices and processes against defined standards. These standards often provide clarity on what is expected at different maturity levels for various tenets and principles of site reliability engineering, helping organizations to identify areas of improvement and set clear goals for progress.

### SUMMARY

The illustrative embodiments provide for site reliability engineering maturity assessment and workload management.

An embodiment includes defining a plurality of tenets, a tenet in the plurality of tenets representing a principle of site reliability engineering. This step provides a structured foundation for evaluating the reliability of different components and systems. By standardizing the principles of site reliability engineering, organizations can ensure consistent benchmarks and measurements across various hybrid cloud components and applications. This foundational framework facilitates clearer evaluations, comparisons, and goal-setting for reliability objectives.

The embodiment also includes generating a first site reliability engineering maturity assessment for a first hybrid cloud component, a second site reliability engineering maturity assessment for a second hybrid cloud component, and a third site reliability engineering maturity assessment for an application. This stage offers a granular perspective on the maturity levels of individual components and the application itself. With specific assessments for each component and the application, organizations can pinpoint areas that require attention, improvements, or optimization. This granularity enhances the precision of the evaluation and allows for tailored strategies for each component.

The embodiment also includes determining a workload placement for the application based on the first, second, and third site reliability engineering maturity assessments. This decision-making process, grounded in comprehensive assessments, ensures optimized workload placements. By basing the placement on the reliability maturity of the various components, the application performance and stability may be increased.

The embodiment also includes initiating a workload migration for the application based on the workload placement. This proactive action, guided by the prior steps, ensures that applications run in environments best suited to their reliability needs. By migrating workloads based on informed decisions, there may be a reduction in potential downtimes, improved resource utilization, and more efficient cloud cost management.

The culmination of these steps in the embodiment provides an integrated approach to site reliability engineering. It helps ensure that applications are hosted in the most suitable environments, maximizing both performance and cost-effectiveness. The systematic approach enhances the reliability and efficiency of applications across hybrid cloud environments. By ensuring each component and application aligns with standardized reliability principles, organizations can drive consistency, reduce issues, and offer a superior user experience.

In an embodiment, the plurality of tenets includes at least one of scaling operations with load, capping operational load, overflow handling, service level agreements, operational readiness reviews, error budgeting, observability, end-user alerts handling, and blameless post-mortems. This comprehensive set of tenets provides a multifaceted view of site reliability. With tenets that encompass both technical and procedural aspects of reliability, this broad scope helps ensure that areas impacting system stability and performance are accounted for.

In an embodiment, defining a plurality of tenets further may include defining a plurality of tenet dimensions associated with the plurality of tenets. By establishing tenet dimensions, the reliability assessment becomes multi-dimensional, providing depth to each tenet. This allows for a more granular evaluation, where each aspect of a tenet can be individually assessed and optimized, thereby enhancing the accuracy and actionable insights derived from the evaluation.

In an embodiment, the plurality of tenet dimensions includes at least one of security, high availability, disaster recovery, storage, networking, incident response, and deployment. These dimensions cover a wide spectrum of infrastructure and operational areas critical to system performance and safety. This comprehensive coverage ensures that areas of potential vulnerability or inefficiency are identified and addressed, resulting in a more resilient and performant system.

In an embodiment, generating the site reliability engineering maturity assessment may include assigning a value for a tenet dimension in the plurality of tenet dimensions; and assigning a weight for the tenet dimension in the plurality of tenet dimensions. By assigning values and weights, the assessment process becomes quantitative, allowing for objective comparisons and evaluations. This systematic approach facilitates prioritization, ensuring that critical dimensions receive the attention they deserve, and fosters data-driven decision-making.

In an embodiment, determining the workload placement for the application further may include: computing a first difference between the first site reliability engineering maturity assessment for the first hybrid cloud component and the third site reliability engineering maturity assessment for the application; computing a second difference between the second site reliability engineering maturity assessment for the second hybrid cloud component and the third site reliability engineering maturity assessment for the application; and determining the workload placement based on the first difference and the second difference. This method provides a clear comparison between the maturity assessments, allowing for precise placement decisions. By comparing differences, organizations can objectively identify the most compatible environment for the application, optimizing performance and cost.

In an embodiment, the first difference and the second difference are computed as a difference between a value associated with each tenet in the plurality of tenets scaled by a weight associated with each tenet. By scaling the differences using weights, the assessment incorporates the importance or priority of each tenet. This ensures that more critical tenets have a greater influence on the decision-making process, resulting in more informed and strategic workload placements.

An embodiment further includes generating a report for at least one of the first, second, and third site reliability engineering maturity assessments. Generating a report consolidates the findings from the assessments into a digestible format. This not only aids in communicating the insights to stakeholders but also provides documentation for future reference, accountability, and continuous improvement.

In an embodiment, the first, second, and third site reliability engineering maturity assessments are generated based on a trigger event associated with at least one of the first hybrid cloud component, the second hybrid cloud component, and the application. Using trigger events ensures that assessments are timely and relevant. By basing assessments on specific events, like system changes or performance anomalies, the evaluation remains dynamic and adaptive to the current state of the system, ensuring that decisions are always based on the most up-to-date information.

The combined advantages of these embodiments culminate in a holistic and adaptive site reliability engineering framework. The methodology's depth, from defining multi-dimensional tenets to event-driven assessments, provides a robust platform for ensuring optimal system performance and reliability. Through this structured and comprehensive approach, organizations can ensure high availability, security, and efficiency of their applications across diverse cloud environments, ultimately leading to improved user experiences and operational efficiencies.

In one embodiment, the process entails defining a diverse set of tenets representative of site reliability engineering. These tenets encompass facets such as scaling operations with load, capping operational load, and overflow handling, among others. Additionally, associated with these tenets are various tenet dimensions, which might include components like security, high availability, and incident response. This embodiment is further enhanced by its responsiveness: it employs trigger events stemming from hybrid cloud components to instigate the creation of site reliability engineering maturity assessments. An alternative or supplemental perspective on this embodiment emphasizes its multifaceted nature; the inclusion of tenet dimensions in the definition of tenets augments the depth of the evaluations, making them comprehensive. Moreover, generating assessments grounded in real-time trigger events ensures that decisions are constantly aligned with the most recent and pertinent data, ensuring dynamism and adaptability.

This embodiment weaves together an intricate network of tenets, dimensions, and trigger events to forge a robust blueprint for system excellence across multifarious cloud environments. The ultimate beneficiary is the end user, who enjoys enhanced user experiences, while on the operational side, efficiencies are realized. The individual feature of incorporating tenet dimensions into the evaluations fine-tunes the process, facilitating a granular assessment of each facet of a tenet. This helps ensure that every nuance can be scrutinized and optimized. Moreover, by having a system that continuously recalibrates its assessments based on unfolding events, it is always in step with real-world changes, thus ensuring dynamism and adaptability.

Consider the scenario of an e-commerce platform operating within a hybrid cloud framework. With the arrival of a holiday (e.g., Black Friday), a spike in traffic may be inevitable. Due to this event, system reliability may become a necessity. In this scenario, the tenet of “scaling operations with load” might be enriched with dimensions like high availability and incident response. As the platform gears up for the holiday, a trigger event, such as a brief system outage in one cloud provider in the hybrid cloud, could prompt the generation of a reliability assessment leading to workload migration to another cloud provider. With the dimension of high availability in the spotlight, the platform can effortlessly ride the waves of high traffic. Concurrently, the incident response dimension may act as a safety net, ensuring a similar intervention in the face of unexpected challenges. The culmination of this is an event where the e-commerce platform not only survives the surge but thrives, leading to increased customer trust and driving sales.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment.

FIG. 2 depicts a block diagram of an example software integration process in accordance with an illustrative embodiment.

FIG. 3 depicts a block diagram of an example hybrid cloud environment in accordance with an illustrative embodiment.

FIG. 4 depicts a block diagram of an example process for site reliability engineering maturity assessment and workload management in accordance with an illustrative embodiment.

FIG. 5 depicts a block diagram of an example process for generating a site reliability engineering maturity assessment in accordance with an illustrative embodiment.

FIG. 6 depicts a block diagram of an example process for identifying a cloud provider for workload placement in accordance with an illustrative embodiment.

FIG. 7 depicts a block diagram of an example site reliability engineering maturity assessment report in accordance with an illustrative embodiment.

FIG. 8 depicts a block diagram of an example site reliability engineering maturity assessment report in accordance with an illustrative embodiment.

FIG. 9 depicts a block diagram of an example process for site reliability engineering maturity assessment and workload management in accordance with an illustrative embodiment.

### DETAILED DESCRIPTION

Site reliability engineering (SRE) is a discipline that incorporates aspects of software engineering and applies them to infrastructure and operations problems. Its goals include the creation of scalable and highly reliable software systems. Site reliability engineering is based on the principles of reliability, scalability, and performance. As part of their responsibilities, site reliability engineers often undertake assessments to evaluate the maturity of a client's operations, leading to a well-defined path to address different aspects of the operations' performance.

A maturity assessment may be used to identify where a client is at a point in time concerning site reliability engineering tenets, which may cover the end-to-end of a solution's availability, resilience, innovation, process streamlining, gaps in tools, operational excellence, impending risks, and more. It may serve as a framework to guide and benchmark a client's practices and processes against defined standards. These standards often provide clarity on what is expected at different maturity levels for various tenets and principles of site reliability engineering, helping organizations to identify areas of improvement, and may help migrate in line with the site reliability engineering tenets for a superior delivery.

A hybrid cloud environment refers to an information technology architecture where an organization uses a combination of on-premises private cloud resources and third-party public cloud resources. The benefit of this setup is that it allows organizations to keep sensitive data on their private cloud while leveraging the computational power and scalability of the public cloud for other tasks. Managing workloads in a hybrid cloud may be complex, as it may involve deciding where to deploy various components of an application or service-either in the private or public cloud. This distribution must align with the client's needs, security requirements, cost considerations, and other factors.

If the distribution deviates from the standards set in the maturity assessment, it can lead to inefficiencies, higher costs, or potential security risks. Additionally, with multiple cloud vendors available, each with its unique offerings, strengths, and limitations, determining the optimal vendor for specific workloads may become a significant challenge. Ensuring that the workload distribution aligns with the maturity assessment standards and choosing the appropriate cloud vendor are often important elements in achieving the desired level of reliability, efficiency, and security in a hybrid cloud environment.

One of the challenges in today's information technology landscape is the effective distribution of workloads across a hybrid cloud infrastructure. Traditional methods of managing and distributing these workloads often rely on predefined rules and algorithms that do not fully take into account the specific needs, complexities, and dynamic nature of modern applications and services. These methods can lead to suboptimal performance, increased costs, and potential security risks. Furthermore, the lack of integration with principles such as those outlined in a maturity assessment can hinder an organization's ability to align workload distribution with strategic goals and quality standards. This misalignment often results in a distribution that does not reflect the actual needs and maturity levels of the client's operational practices.

The present disclosure addresses the deficiencies described above by providing a process (as well as a system, method, machine-readable medium, etc.) that dynamically provisions or migrates workload distribution by selecting an optimal cloud infrastructure in a hybrid cloud environment. This selection may be based on a site reliability engineering maturity assessment and site reliability engineering tenets. The process may include generating a maturity assessment dynamically for the client's application(s) that is already running or planned to be deployed, performing this assessment dynamically for cloud providers in the hybrid cloud infrastructure, and finding the best match to deploy the application(s) dynamically. Considerations may include error mitigation through clear understanding of error budgets, workload capacity to handle the number of users, mitigation measures during outages, understanding the criticality of the application, planning for migrations or upgrades with clear checklists, and managing dependencies among multiple products used in the cloud to ensure synchronization and load management, among others.

Illustrative embodiments provide for use of a site reliability engineering maturity engine. A “site reliability engineering maturity engine,” as used herein, may refer to a specialized system or framework designed to evaluate the maturity level of site reliability engineering practices within a given application or infrastructure. This engine may integrate diverse metrics and methodologies, such as real-time monitoring, historical data analysis, and predictive modeling. For instance, when assessing a cloud provider's security protocols, it could examine firewall configurations, penetration test results, and incident response times, ensuring comprehensive scrutiny. This engine may aid in determining the alignment and compatibility of an application's requirements with potential infrastructures (e.g., cloud providers or on-premises infrastructure) based on predetermined site reliability tenets. An application's demand for site reliability engineering tenets or tenet dimensions, such as security or high availability, for instance, might be assessed against the capabilities of various cloud providers. For example, by leveraging this engine, an e-commerce application with high transaction rates might find a cloud provider that specializes in high availability, ensuring minimal downtime during peak sales periods. This granular comparison may enable organizations to make informed, data-driven decisions about workload placements and/or migrations.

Illustrative embodiments provide for defining a plurality of tenets. A “tenet,” as used herein, may refer to a principle of site reliability engineering. This may refer to a principle or practice of site reliability engineering or other desired attributes of software applications and systems. These tenets may act as benchmarks that ensure software applications and systems are resilient, scalable, and reliable. For instance, the tenet focusing on “error budgeting” might address how much downtime or error rate is permissible within a given timeframe, enabling teams to gauge system reliability and prioritize improvements. If, for instance, an application's error budget is exhausted within the first week of a month due to frequent outages, it may become evident that measures are required to enhance the system's stability.

For example, in some embodiments, a tenet may include scaling operations with load, capping operational load, overflow handling, service level agreements, operational readiness reviews, error budgeting, observability, end-user alerts handling, and blameless post-mortems. Scaling operations with load may involve adjusting operational capabilities based on user demand. Similarly, capping operational load may pertain to setting maximum operational thresholds to prevent system overloads. Overflow handling may involve managing any excess demand or traffic in a systematic manner. Service level agreements may represent formalized commitments to a specified level of service. Operational readiness reviews may be evaluations of a system's state of readiness for operational demands. Error budgeting may allow for allocating a certain permissible amount of system downtime or errors. Observability may involve the ability to monitor and diagnose system states. Handling end-user alerts may involve efficiently managing and responding to alerts that affect the end user. Lastly, blameless post-mortems may involve analyzing system failures without laying blame on individuals, fostering an environment of continuous learning and improvement. Other tenets may be applied, however, as would be appreciated by those having ordinary skill in the art upon reviewing the present disclosure.

Defining a plurality of tenets may involve a systematic process of identifying the key principles that ensure the reliability, scalability, and resilience of a system. For example, in some embodiments, tenets may be defined by a user, such as a developer or hybrid cloud manager. These tenets may be provided through a user interface or any other suitable means for providing the tenets to the system. Additionally or alternatively, the tenets might be automatically detected based on predefined criteria or through machine learning algorithms that analyze system behaviors and patterns. Implementing a machine learning system for suggesting tenets may begin with collecting training data from sources like logs, system metrics, and incident reports, among other sources, as well as tenets associated with that training data. After preprocessing this data, suitable models, such as decision trees or neural networks, may be selected based on the data's nature. The model may be trained using this dataset to understand the relationships between system behaviors and tenets. Once trained, the machine learning model may be integrated into the client's system to assess real-time data and suggest potential tenets based on detected behaviors. The model's accuracy may be continually refined through a feedback loop where a user can verify or correct its suggestions.

Illustrative embodiments provide for defining a tenet dimension associated with a tenet. A “tenet dimension,” as used herein, may refer to a specific attribute or area of focus within a broader tenet, offering a more granular approach to assessing and improving site reliability. For example, under the tenet of “observability,” dimensions could include monitoring tools employed, data logging practices, real-time analytics capabilities, and alert thresholds. In some embodiments, for instance, a tenet dimension may include security, high availability, disaster recovery, storage, networking, incident response, and deployment. In some embodiments, however, these exemplary tenet dimensions may be considered tenets, which may then be broken down into various tenet dimensions, depending on the particular use or application. For instance, “security” may be considered a tenet, and its dimensions might range from two-factor authentication protocols to intrusion detection systems and from vulnerability assessments to periodic security drills. Each of these dimensions may provide a lens through which the maturity of site reliability engineering practices can be viewed and assessed.

Illustrative embodiments provide for generating a site reliability engineering maturity assessment. A “site reliability engineering maturity assessment,” as used herein, may refer to an evaluation of how well an application or infrastructure adheres to the defined site reliability engineering tenets and dimensions. For example, such an assessment might delve into an application's current storage capabilities, security measures, and response strategies, comparing them against best practices or specific criteria. This assessment could scrutinize an application's storage protocols, comparing traditional hard disk drive storage speeds, reliability, and cost to modern solid state drive (SSD) or non-volatile memory express (NVMe) solutions. It might also measure latency, deducing how swiftly an online portal responds to international users.

Generating a site reliability engineering maturity assessment may involve collecting data on the current state of the application or infrastructure, analyzing this data in the context of the defined tenets and dimensions, and producing a score or report. For instance, the assessment might compare an application's disaster recovery strategies against those offered by various cloud providers, helping organizations identify the best match for their needs. This maturity assessment may involve data collection, analytics, and expert evaluations, among others. For instance, simulating a denial-of-service attack can evaluate how robustly a system withstands malicious onslaughts. To illustrate, a cloud-based financial application might prioritize data encryption and rapid disaster recovery. By assessing these areas, organizations can pinpoint which cloud providers align with their security and uptime requirements, ensuring that customer financial data remains uncompromised and consistently accessible.

In some embodiments, generating a site reliability engineering maturity assessment may involve assigning a value to each tenet or tenet dimension. A “value,” as used herein, may refer to a quantifiable or qualitative representation that indicates the extent to which a particular tenet or dimension is satisfied or adhered to within an application or infrastructure. For example, a security tenet might be assigned a value on a scale of 0-40, with 40 indicating optimal security practices, based on the robustness of encryption protocols, firewall settings, and access control mechanisms in place, among other factors. For example, an application employing AES-256 encryption might receive a value of 35, while one with basic encryption might receive a value of 10.

Moreover, in some embodiments, generating a site reliability engineering maturity assessment may involve assigning a weight to each tenet or tenet dimension. A “weight,” as used herein, may refer to the relative importance or priority of a tenet or tenet dimension in the context of assessing the maturity of site reliability engineering practices. A higher weight could mean that failure or sub-optimality in that dimension has greater repercussions. For example, for one application, storage might receive a weight of 3.0, indicating a high storage requirement, while security might receive a weight of 1.0, indicating a low security requirement. Other weights may be used, however, as would be appreciated by those having ordinary skill in the art upon reviewing the present disclosure.

In some embodiments, a site reliability engineering maturity assessment may be generated for a hybrid cloud component. A “hybrid cloud component,” as used herein, may refer to an individual element within a combined computing environment that leverages both on-premises resources and cloud-based services. An assessment might evaluate the capabilities of a specific cloud provider in comparison to on-premises infrastructure, for instance, focusing on their respective strengths and weaknesses in terms of site reliability engineering tenets. For example, while one public cloud provider might offer remarkable scalability and elasticity, an on-premises infrastructure might win on latency or data sovereignty considerations, especially if the target audience is local or if there are strict data residency regulations to adhere to.

In some embodiments, a site reliability engineering maturity assessment may be generated for an application. An “application,” as used herein, may refer to a software program or solution designed to fulfill specific functions or tasks within a computing environment. It can range from a simple web application, like a company's website, to complex distributed systems, such as real-time data analytics platforms. Their demands, in terms of site reliability engineering, may differ based on their particular application or use. An application's disaster recovery strategy might be evaluated, for instance, considering how it leverages resources from multiple cloud providers and integrates with on-premises systems. For example, a streaming service may prioritize availability and latency, ensuring that users can stream content without interruptions. Contrast this with a data warehousing solution which might prioritize data integrity, backup solutions, and query optimization over mere availability.

Illustrative embodiments provide for determining a workload placement for an application. A “workload placement.” as used herein, may refer to the strategic allocation of computational tasks or services, ensuring they are hosted in the environment best suited for their requirements. As an example, based on an application's need for high availability, the workload might be placed with a cloud provider known for its robust failover systems and minimal downtime. For example, for a globally distributed e-commerce platform, its workload placement may involve considerations like user demographics, content delivery network capabilities, data storage regulations, and more. It might opt for a multi-cloud strategy, leveraging one cloud provider for its machine learning capabilities in recommendation systems and another cloud provider for its superior data analytics tools.

The process of determining the ideal workload placement may take into account various factors, including cost, performance, and alignment with site reliability engineering principles. If an application requires rapid data access and the on-premises infrastructure offers the shortest latency, for instance, then the on-premises option might be favored for workload placement. For example, for a data-intensive application like a genome-sequencing platform, proximity to data storage and high-speed computation might be paramount. In such cases, if the on-premises infrastructure boasts solid state drive arrays with parallel processing capabilities, it may be favored for placement over cloud solutions with potential data ingress and egress bottlenecks.

In some embodiments, determining the workload placement may be based on site reliability engineering maturity assessments associated with the application and hybrid cloud components. By juxtaposing the application's assessment with those of potential hosting options, one can chart a course that aligns best with technical demands and business objectives. The workload placement may be based, for instance, on reliability engineering maturity assessments associated with the application and two or more cloud providers and/or on-premise infrastructures. For example, consider two cloud providers: Provider A might score high on storage capabilities but lags in networking, while Provider B is the opposite. If an application's dominant demand is data storage with periodic synchronization, Provider A may become the logical choice despite its networking shortcomings. The differential scoring method, such as when values are scaled by weights, provides a mathematical foundation to these decisions, ensuring that they are objective and reproducible.

In some embodiments, determining the workload placement for the application may involve computing differences between the site reliability engineering maturity assessment of the application and the hybrid cloud components. In embodiments where a value and weight is assigned to each tenet or tenet dimension, for instance, the embodiments may further involve computing differences between a value associated with each tenet scaled by a weight associated with each tenet. For example, if a tenet or tenet dimension for the application is assigned a value of 40 and a weight of 2.0, and the tenet or tenet dimension for the cloud provider is assigned a value of 30, then the difference may be computed as 20, which is equivalent to the difference between the values (40-30) multiplied by the weight of 2.0. This process may be repeated with other hybrid cloud components (e.g., other cloud providers or on-premises infrastructure). The workload placement may be based on the computed difference. For instance, the workload placement may be determined as the hybrid cloud component with the smallest difference. Following the example above, if another hybrid cloud component had a value of 35 for the tenet or tenet dimension, then that hybrid cloud component may be chosen for the workload placement, since it would have the smallest difference (10 versus 20). Other approaches may be used however (e.g., choosing the largest difference instead), as would be appreciated by those having ordinary skill in the art upon reviewing the present disclosure.

Illustrative embodiments provide for initiating a workload migration for the application based on the workload placement. A “workload migration,” as used herein, may refer to the process of transferring computational tasks, services, or data from one computing environment to another. This process might involve not only the migration of raw data but also configurations, dependencies, services, or network topologies to ensure continuity and minimize operational disruption. For instance, this could mean moving an application from an on-premises data center to a public cloud environment because the latter offers better scalability, security, and cost-efficiency for that specific application.

The act of initiating a workload migration may involve numerous considerations and preparatory steps, ranging from assessing the compatibility of the target environment to mapping out the migration path for smooth transition. Prior to migration, for instance, there may be a need to ensure that the application's dependencies are adequately catered for in the new environment or that data integrity checks are in place to validate the successful transfer of data. For instance, migrating an enterprise-level application from an on-premises data center to a public cloud might necessitate evaluations of data transfer speeds, potential egress charges, data integrity checks during migration, and compatibility checks for any platform-specific software or services. The goal may be to leverage the scalability, resilience, and possibly cost-effectiveness of the cloud environment.

Illustrative embodiments provide for generating a report a site reliability engineering maturity assessment. A “report,” as used herein, may refer to a document or digital output that encapsulates the findings, scores, weights, or insights derived from the assessment process, offering actionable recommendations. For example, this report might showcase how well an application adheres to site reliability engineering tenets such as observability, scalability, or disaster recovery and suggest workload migration to another hybrid cloud component. A report may be represented in any suitable format, perhaps in formats like PDFs or interactive dashboards. It may detail the nuances of the assessment, encapsulating metrics, benchmarks, identified strengths, and areas necessitating workload migration. The generation of such a report may involve data compilation, analysis, and presentation to ensure the conveyed information is accurate, relevant, and actionable. The process might involve aggregating data from various monitoring tools, conducting comparative analysis against industry benchmarks, and visualizing the findings in graphs or charts for case of comprehension.

Illustrative embodiments provide for generating a reliability engineering maturity assessment based on a trigger event associated with the application or a hybrid cloud component. A “trigger event,” as used herein, may refer to a notable occurrence or change in the operational environment that warrants a fresh evaluation of the application's or component's reliability maturity. An illustrative example could be a significant application update, a shift in traffic patterns, or the integration of a new cloud service which might impact the existing reliability metrics. For instance, if an application integrates with a third-party service hosted on another cloud provider, and that service faces an unexpected security breach, it might be imperative to reevaluate the application's security posture. Responding to such trigger events by generating a reliability engineering maturity assessment may involve a proactive approach to reassess and recalibrate the current reliability strategies, ensuring sustained optimal performance. As an illustration, upon detecting a sudden surge in user traffic, an immediate assessment might be conducted to ensure that the application's scalability and performance tenets are still aligned with the current demands, leading to possible workload migrations if discrepancies are found.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose. and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The process software for site reliability engineering maturity assessment and workload management is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

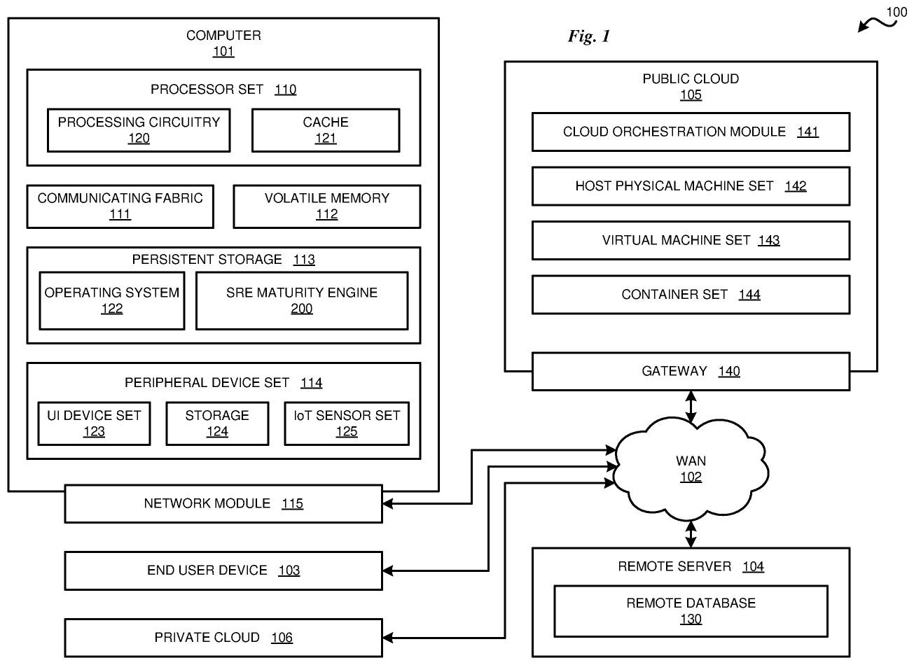

With reference to FIG. 1, this figure depicts a block diagram of a computing environment 100. Computing environment 100 contains an example of an environment for the execution of at least some of the computer code involved in performing the inventive methods, such as site reliability engineering maturity engine 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

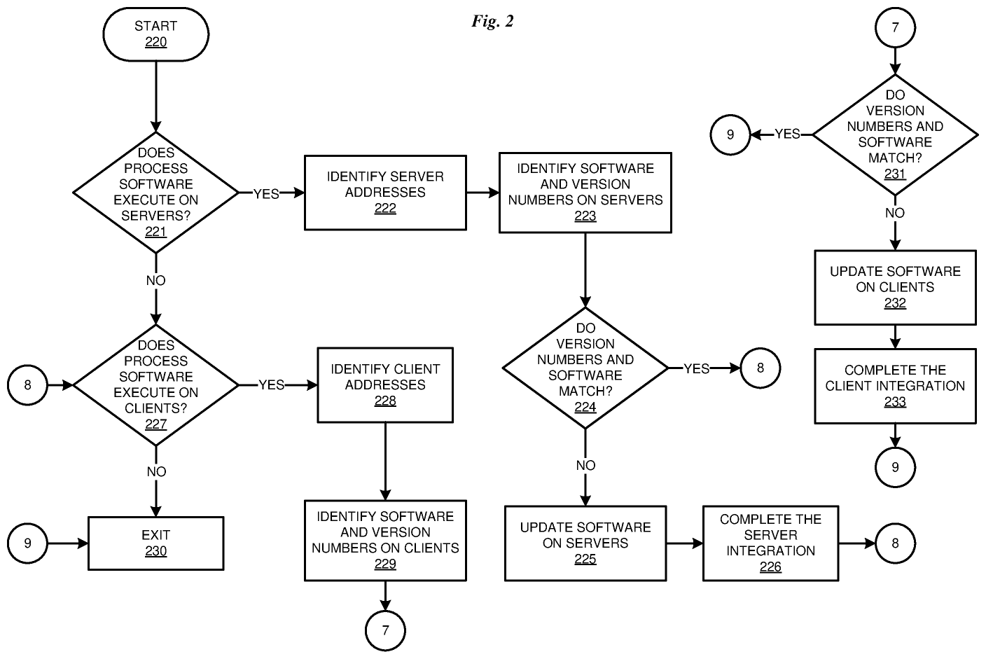

With reference to FIG. 2, this figure depicts a block diagram of an example software integration process, which various illustrative embodiments may implement. Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

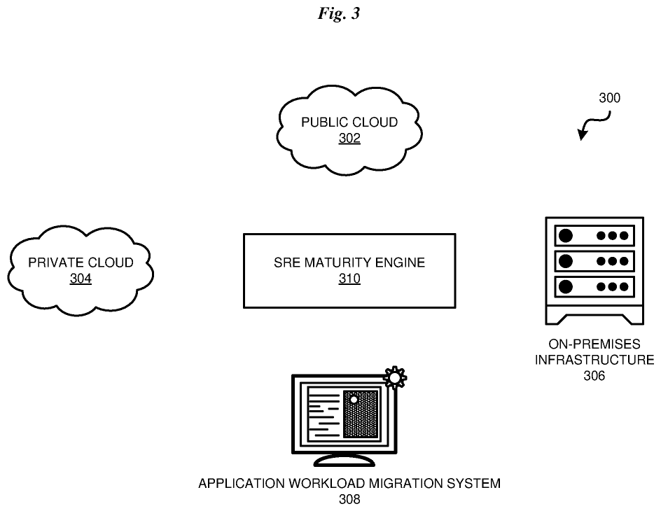

With reference to FIG. 3, this figure depicts a block diagram of an example hybrid cloud environment 300 for site reliability engineering maturity assessment and workload management. It is to be understood that hybrid cloud environment 300 may comprise additional or fewer components than those shown in the illustrative embodiment.

In the depicted example, public cloud 302 may represent a portion of the hybrid cloud environment where services are provided by a third-party provider. This cloud could host non-sensitive data and provide computational resources for various tasks. For example, it might be used to leverage additional processing power during peak usage times, such as extra CPU cores or memory for various tasks. For instance, it might be used to leverage additional processing power during a product launch event or to handle sudden spikes in web traffic, thereby ensuring that the system remains scalable and responsive.

Private cloud 304 may represent the organization's internally hosted cloud resources, often utilized for more sensitive data or specific regulatory compliance. This data could include financial information, personal employee data, or proprietary business algorithms, among others. For instance, a financial institution might store critical account information within the private cloud, allowing for controlled access and robust security protocols, while also enabling customized reporting and analysis tools tailored to the organization's unique needs.

On-premises infrastructure 306 may represent the physical hardware and software that resides within the organization's facility. It can include servers, networking equipment, storage devices, and more, which may be managed by in-house information technology staff. This infrastructure may be used for critical applications that require complete control and high security. It may be used to host a database that is used by the organization's core functions. For example, a manufacturing company may host its inventory management system on-premises, ensuring low latency access and a high degree of control over the data, facilitating real-time updates and integration with other key operational systems like production planning or quality control.

Application workload migration system 308 may represent a system or process for moving applications between the public cloud, private cloud, and on-premises infrastructure. This migration may be based on the needs, requirements, and maturity assessment of the client. For instance, an application might be migrated to the public cloud to take advantage of additional resources, then moved back to the private cloud for long-term stability and security. This process could include utilizing tools like Kubernetes or Terraform to facilitate migration. For example, a retail business might move an e-commerce application to the public cloud during a seasonal sale to access extra resources and then migrate it back to the private cloud for ongoing operation, optimizing costs and performance.

Site reliability engineering maturity engine 310 may represent a specialized tool or system designed to evaluate the maturity level of the organization's site reliability engineering practices and manage the distribution of workloads across the hybrid cloud infrastructure, as explained herein. It may integrate machine learning algorithms or other types of algorithms to analyze historical performance data and align with the client's site reliability engineering maturity. This engine may interact with various components (e.g., public cloud 302, private cloud 304, on-premises infrastructure 306, or application workload migration system 308) to ensure optimal performance, efficiency, and security. It may analyze the requirements of a specific application and decide the best location for deployment, taking into account factors such as error budgets, workload capacity, criticality, and dependencies among multiple products. For example, it could assess an application's security, high availability, disaster recovery, storage, networking, incident response, and deployment, among other factors, and then automatically adjust the distribution across the hybrid cloud to maintain service levels, reduce costs, and minimize risks, ensuring synchronization and effective load management. It may thereafter interact with application workload migration system 308 to initiate the migration, or it may be configured to handle the migration process itself.

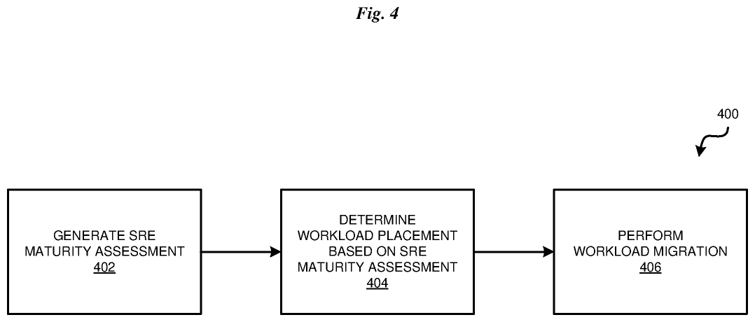

With reference to FIG. 4, this figure depicts a block diagram of an example process for site reliability engineering maturity assessment and workload management in accordance with an illustrative embodiment 400. The example block diagram of FIG. 4 may be implemented using site reliability engineering maturity engine 200 of FIG. 1.

In the illustrative embodiment, at block 402, the process may generate a site reliability engineering maturity assessment. A site reliability engineering maturity assessment may represent a systematic evaluation that measures an organization's proficiency and effectiveness in applying site reliability engineering principles and practices. This assessment may gauge the organization's capability in ensuring the reliability, scalability, and performance of their software systems and operational infrastructure. By determining the maturity level, the assessment may provide insights into areas of strength and potential gaps, thereby offering actionable recommendations for improvement in line with site reliability engineering best practices. These assessments may be constructed for various elements within the hybrid environment, including but not limited to the client's application, public clouds, private clouds, and on-premises infrastructures. The procedure for formulating this maturity assessment may cover multiple site reliability engineering tenets, such as scaling operations with load, capping operational load, overflow handling, service level agreements, operational readiness reviews, error budgeting, observability, end-user alerts handling, and blameless post-mortems. Dimensions such as security, high availability, disaster recovery, storage, networking, incident response, and deployment may also be considered.

Generating a site reliability engineering maturity assessment may involve initiating and extending an orchestration operator, collecting details about site reliability engineering maturity tenets, and/or providing visual reports about the cloud vendors' infrastructure and applications' deployment structure. For example, this process may involve extending Kubernetes application programming interface (API) to capture dynamic data such as CPU, RAM, and storage consumption. It may also involve calculations including various factors such as application services request/response behavior, dependencies on other services, and failure rates, among others. Reports might be visualized using a user interface using charts (e.g., radar or spider charts), giving a complete view of the current status of different tenets, thereby helping in workload distribution decisions.

The site reliability engineering maturity assessment may be generated periodically or dynamically. For instance, the assessment might be scheduled to run periodically, such as daily or hourly intervals, ensuring that the organization's adherence to site reliability engineering practices is continually monitored and up-to-date. Moreover, specific triggers may instigate an immediate analysis. An example may be a security breach or any significant event that may compromise the system's reliability. In such cases, an immediate assessment may become imperative to gauge the potential impact on the organization's site reliability engineering maturity and to take the necessary corrective actions. This dynamic and responsive approach may ensure that the system remains robust, agile, and continually aligned with best SRE practices, regardless of the operational landscape's evolving nature.

At block 404, the process may determine a workload placement based on the site reliability engineering maturity assessment. Workload placement in this context may pertain to the strategic allocation of computational tasks and services within a hybrid environment to optimize efficiency, cost, or performance. The act of determining a workload placement may involve calculations and considerations to ensure optimal operational effectiveness. In some embodiments, for example, a workload placement may be based on a best match between the application's site reliability engineering maturity assessments of an application and cloud providers, private clouds, or on-premises infrastructure. This process may involve an analysis of the client's current maturity level, desired workload requirements, and alignment with predefined site reliability engineering tenets, among other factors. For example, if a new application is being deployed, the process may assess the site reliability engineering tenet values for that application and find the best match based on existing values. If a new application demands reliable storage, for instance, the process may assess the site reliability engineering values before actual deployment and compare it with existing values for each dimension required for the new application. If the application is already deployed, it may follow specific configurations like manual or best match to place the workload appropriately.

Determining the best match may involve evaluating several factors to identify the optimal cloud provider or environment for a particular workload within the context of site reliability engineering. This process may include considering the values and principles underlying site reliability engineering, such as technical requirements, operational maturity, cost factors, regulatory compliance, and strategic organizational objectives, among others. The best match may also align with the client's specific maturity assessment, which may reflect the current state of their operations in relation to site reliability engineering principles, ensuring compatibility with their existing and future requirements. Attention may also be paid to the unique needs of different workloads, such as storage reliability or specific security protocols, and how these align with various providers. Cost consideration may also play a role, requiring an evaluation of the cost structure of different providers to find an option that meets budgetary constraints.

At block 406, the process may perform workload migration. Workload migration in this context may refer to the process of transferring applications, services, and related data between different computational environments. This can be based on the values or changes thereof in the site reliability engineering maturity assessment. It may also involve filling the gaps for site reliability engineering tenets value requirements for critical applications, understanding new site reliability engineering tenets or dimensions, and readjusting workload distributions and migrations as necessary. These value changes may represent alterations in the client's infrastructure, security policies, or changes in application requirements. For example, a new security vulnerability across a cloud vendor might trigger a change in the maturity's value. In such a scenario, the process might trigger a migration to a vendor that has already patched their services in view of that new security vulnerability. Performing workload migration based on these value changes may involve algorithms that dynamically assess the best cloud vendor for specific workload requirements, such as scalability in maintaining the reliability of an application. Another example could be a scenario where the client's maturity assessment identifies the necessity for a more robust and secure storage solution. This real-time assessment and responsive action may help ensure that the workload distribution aligns with the current needs and maturity levels of the client's operational practices, resulting in optimal performance, cost efficiency, and security.

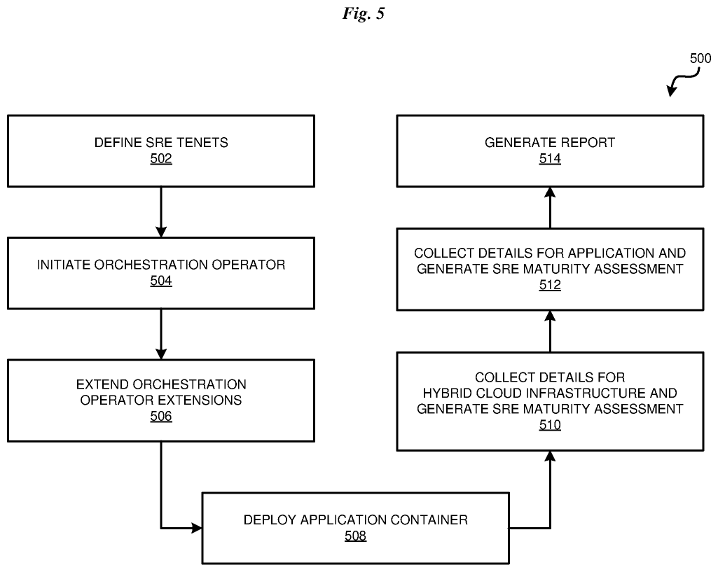

With reference to FIG. 5, this figure depicts a block diagram of an example process for generating a site reliability engineering maturity assessment in accordance with an illustrative embodiment 500. The example block diagram of FIG. 5 may be implemented using site reliability engineering maturity engine 200 of FIG. 1.

In the illustrative embodiment, at block 502, the process may define site reliability engineering tenets. A site reliability engineering tenet may represent a guiding principle or best practice for ensuring that systems are scalable, reliable, and efficient. These tenets might include, for example, scaling operations with load, capping operational load, overflow handling. service level agreements, operational readiness reviews, error budgeting, observability, end-user alerts handling, and blameless post-mortems. Each tenet might have one or more dimensions, such as security, high availability, disaster recovery, storage, networking, incident response, and deployment, among others. They may be part of a set of site reliability engineering tenets provided by a site reliability engineering team or another guiding user, such as through a user interface or other suitable process, during the designing of an application or the setup of the system. Defining a reliability engineering tenet may involve setting up specific goals or benchmarks that a system or service must meet and creating a plan to achieve those standards. Site reliability engineering tenets may change over time and may be dynamically incorporated into the site reliability engineering maturity assessment.

At block 504, the process may initiate an orchestration operator. An orchestration operator may represent a software component that automates the management, scaling, or deployment of containers and services, among other functions. For example, in a Kubernetes environment, this process might include automating the deployment of pods and managing their lifecycle. Initiating an orchestration operator may involve configuring the operator to work with specific systems or applications, defining its behavior and interactions within the environment.

At block 506, the process may extend the orchestration operator's extensions. An extension may represent additional functionalities or customizations added to the orchestration operator to tailor its behavior to specific needs. Extensions might include custom monitoring tools or integration with other cloud services. Extending the orchestration operator's extensions may involve programming new functionalities, configuring existing ones, or integrating third-party tools. Extensions might be used, for instance, to capture dynamic information related to infrastructure and applications such as CPU, RAM, storage consumption, or the deployed application services' request/response behavior, among other information. For example, an extension in the form of a custom resource mechanism, such as an API, may be used to fetch and store the set of site reliability engineering tenets from a Kubernetes environment, or data from the hybrid cloud environment and/or applications as discussed herein.

At block 508, the process may deploy an application container. An application container may represent an isolated environment where a specific application or service runs, encapsulating all the dependencies and configurations. Deploying an application container may involve selecting the appropriate host, configuring the container's settings, and launching it with the necessary resources. For example, an application container, such as a Docker container, may provide an encapsulated environment for running specific applications. It may package the application along with all its dependencies and configurations. Once deployed, these containers in the hybrid cloud infrastructure may serve as the data sources from which the process collects various information.

At block 510, the process may collect details for the hybrid cloud infrastructure and generate a site reliability engineering maturity assessment. This collection may involve obtaining or computing values associated with each site reliability engineering tenet or tenet dimension defined previously. In some embodiments, for example, these values may be predefined (e.g., from a cloud provider's comprehensive guidance and evaluation (CGE) report) or input by a user such as a developer or a hybrid architecture manager obtained from established industry benchmarks, targeted testing, or from their technical expertise. Additionally or alternatively, the process might employ algorithms, such as machine learning models, to compute these values. Such machine learning models may be trained from values associated with other hybrid cloud infrastructure components, such as cloud providers, defined previously.

This collection process may also involve gathering information about the underlying hardware, networking, storage, and other resources across various cloud providers and on-premises infrastructure. For example, this process may include monitoring the performance, utilization, and cost of these resources. The process may actively fetch real-time details about infrastructure components like CPU utilization, RAM usage, and storage allocation, as well as more intricate details such as an application's request/response behavior, its dependencies on other services, or its service failure rate, giving a comprehensive insight into the current deployment structure.

Furthermore, the collection may include obtaining weights to each tenet or tenet dimension based on the particular application or use. These weights may represent the importance of a tenet or tenet dimension for a particular project. For instance, in one project storage might have a weight of 2.0, while security might have a weight of 1.0, indicating that storage is twice as important or valuable as security for that particular project. Again, these weights may be predefined or set by a user (e.g., a developer), with their intimate knowledge of the project. Additionally or alternatively, algorithms or machine learning processes may be employed to determine or dynamically adjust these weights, drawing from historical trends, prior outcomes, or user feedback, among other factors. From these and/or other collected data, the process may generate a site reliability engineering maturity assessment for the hybrid cloud infrastructure.

At block 512, the process may collect details for the application and generate a site reliability engineering maturity assessment. Similar to the collection for the hybrid cloud infrastructure, the collection for the application may involve acquiring or computing values corresponding to each previously established site reliability engineering tenet or tenet dimension. In some embodiments, for example, these values may be directly sourced from developers, stemming from their understanding of the application's needs or based on user feedback. In other instances, these values might be extracted from comprehensive sources such as technical documentation or they might be defined based on standards the application adheres to. Some values could be extrapolated using algorithms, such as machine learning models, which might be tailored based on specific metrics of the application's performance or behavior.

This collection process may also involve tracking metrics related to application performance, user experience, user engagement, dependencies, response times, error rates, and other operational aspects. Thus, this dynamic collection may not only factor in resource utilization like CPU, RAM, and storage but may also evaluate more intricate metrics like the behavior of deployed application services, their interdependencies, or their failure rates.

Weight associated with each tenet or tenet dimension may also be collected or computed. Weights may represent the relative importance of each tenet or dimension in the context of the application. For instance, for an application that focuses heavily on user privacy, the tenet or dimension pertaining to security might be assigned a greater weight than other tenets or dimensions. These weights can either be provided by stakeholders acquainted with the application or they could be computed, potentially with the assistance of machine learning models that sift through historical data, user feedback, or other pertinent factors to gauge and assign the appropriate weights. From these and/or other collected data, the process may generate a site reliability engineering maturity assessment for the application.

At block 514, the process may generate a report. A report may represent a comprehensive set of information detailing the findings, analyses, or recommendations based on the collected data or site reliability engineering maturity assessments. The report might summarize the current state of system reliability, highlight areas for improvement, and propose specific actions to enhance performance and stability. The report may be visually presented using graphical tools like radar/spider charts. For instance, if one of the primary site reliability engineering tenet dimensions for workload distribution is storage, the generated report can offer insights into a cloud vendor's performance in storage provision, revealing which cloud provider offers a better value, or how the current storage system fares in a real-time assessment.

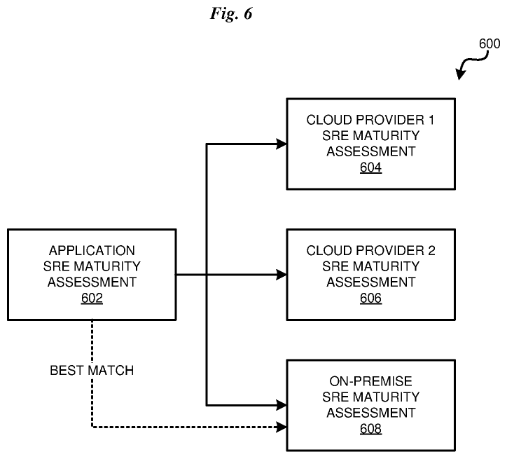

With reference to FIG. 6, this figure depicts a block diagram of an example process for identifying a cloud provider for workload placement in accordance with an illustrative embodiment 600. The example block diagram of FIG. 6 may be implemented using site reliability engineering maturity engine 200 of FIG. 1.

In the depicted example, application site reliability engineering maturity assessment 602 may represent an application's demand for site reliability engineering tenets or tenet dimensions such as security, high availability, disaster recovery, storage, networking, incident response, and deployment, among others. This assessment might include, for instance, a review of the application's current storage capabilities, security measures, response to incidents, and deployment strategies. For example, the security aspect may involve an examination of encryption protocols, firewalls, and access control. High availability and disaster recovery could include redundancy plans and failover systems. The assessment of storage might include a review of capacity, speed, and redundancy, while networking could examine bandwidth, latency, and topology. Incident response may assess the preparedness and strategy for handling unexpected failures, while deployment might focus on automation, rollbacks, and blue-green deployment strategies. These examples are intended to be illustrative only, as will be appreciated by those having ordinary skill in the art upon reviewing the present disclosure.

Cloud provider site reliability engineering maturity assessment 604 may represent a similar evaluation, but focused on the infrastructure and services offered by a particular cloud provider. This assessment might cover the provider's ability, for instance, to meet certain storage, security, or high availability requirements that align with the application's needs. For example, this assessment could encompass an in-depth evaluation of the provider's capabilities in security, high availability and disaster recovery, storage, networking, incident response, and deployment. A detailed examination of the storage solutions might reveal options such as solid state drives, network-attached storage (NAS), and object storage with various redundancy and performance attributes. Security measures could include distributed denial-of-service (DDoS) protection, encryption, and secure virtual private network (VPN) connectivity, while networking capabilities might encompass high-speed interconnections and dedicated lines.

Cloud provider site reliability engineering maturity assessment 604 may represent an assessment for a different cloud provider, focusing on similar aspects but potentially offering different solutions that may or may not align more closely with the application's requirements. For example, this assessment may delve into similar aspects but may reveal different strengths or weaknesses, such as better storage solutions with advanced features like automated tiering, enhanced data replication, or integrated backups. The provider's unique capabilities, such as specific disaster recovery services or advanced monitoring and alerting systems, might be important for certain applications, offering alignment with the specific requirements.

On-premise site reliability engineering maturity assessment 606 may represent an evaluation of an organization's own in-house infrastructure in terms of the aforementioned site reliability engineering tenets or dimensions. This assessment might include considerations of storage capacity, network architecture, incident response plans, and deployment processes. For example, it might encompass a careful review of existing storage capacities, network architectures, security protocols, incident response plans, and deployment processes. On-premise storage might be evaluated for its capacity, scalability, performance, and ability to integrate with existing systems. Incident response could involve an examination of existing runbooks, alerting mechanisms, and recovery strategies, while deployment processes may include continuous integration/continuous deployment (CI/CD) pipelines and container orchestration.

As shown, the process may perform a matching algorithm to determine the best match for the application based on its site reliability engineering maturity assessment and those associated with the hybrid cloud components, such as cloud providers and/or on-premises infrastructure. If an application has particularly intensive storage requirements, for instance, the algorithm might consider the storage requirements of the application and match it with the provider that best meets those needs in terms of capacity, performance, cost, or other relevant factors. The matching algorithm may thus analyze the values associated with the available providers, focusing particularly on the storage tenet dimension, and determine that the best match is the provider with the highest storage value. For example, if an application requires high-throughput storage with low latency, resulting in a high storage tenet requirement, the algorithm might favor a provider offering high-speed solid state drive arrays with a robust replication strategy-in the depicted example being the on-premises architectures based on the on-premise site reliability engineering maturity assessment 608.

This matching process may involve comparing the application's site reliability engineering maturity assessment values against those of the various options, and it may involve leveraging multi-dimensional analysis to identify the best match for the application. For example, in embodiments where the process computes values for each site reliability engineering tenet or tenet dimension, the process may compute the differences between each value associated with the application and each available option, identifying the option with the smallest total difference. Moreover, in embodiments where each tenet or dimension is associated with a particular weight, the process may increase or decrease each value's contribution to the overall decision based on the weight. For instance, if the weight of a particular tenet is 2.0, the process may multiply that difference by 2.0 when computing the total difference between the application's assessment and each of the options.

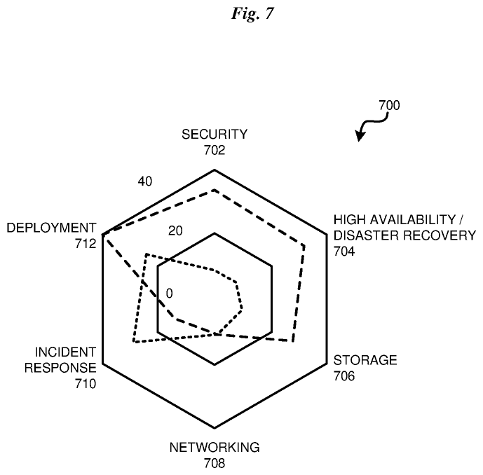

With reference to FIG. 7, this figure depicts an example site reliability engineering maturity assessment report 700 in accordance with an illustrative embodiment. The example site reliability engineering maturity assessment report of FIG. 7 may be generated using site reliability engineering maturity engine 200 of FIG. 1.

As depicted in the illustrative example, site reliability engineering maturity assessment report 700 may comprise security value 702, high availability and disaster recovery value 704, storage value 706, networking value 708, incident response value 710, and deployment value 712. It is to be understood that a site reliability engineering maturity assessment report may comprise additional, fewer, or different tenets or data than what is shown in the illustrative embodiment. Moreover, although the values are depicted in a range between 0 and 40, any other range may be used depending on the particular use or application.

As shown in the depicted example, site reliability engineering maturity assessment report 700 may be represented using multiple types of values, such as hardware infrastructure values (depicted by long dashes) and containerization values (depicted by short dashes). Hardware infrastructure values may represent evaluations based on physical components, server setups, networking gear, and the like. For example, these might address the robustness and reliability of physical servers, data storage devices, and networking equipment. Assessing the robustness and reliability of physical servers might include evaluating redundant array of independent disks (RAID) configurations for data redundancy, uninterruptible power supply (UPS) systems, and proper cooling solutions for thermal management. Other considerations could involve network topology design, redundancy in network paths, and compliance with specific security standards.

Containerization values may represent evaluations based on virtualized containers and the underlying orchestrations for running applications. For example, this assessment could address aspects such as the resilience, scalability, and efficiency of container deployments using technologies like Docker and Kubernetes. Container orchestration with Kubernetes may be evaluated for its ability to handle auto-scaling, self-healing, and rolling updates. Docker container security might be analyzed in terms of proper isolation, secure image sourcing, and utilizing tools for vulnerability scanning.

Security value 702 may represent the degree to which security protocols, measures, and compliance are met. In the depicted example, this value may be relatively high with respect to the hardware infrastructure, indicating strong physical security measures like data encryption and secure server setups. This value may be relatively low with respect to containerization, however, indicating potential vulnerabilities in container configurations. For example, the value may be high for hardware, indicating strong security measures like hardware-level trusted platform module (TPM) for data encryption. Conversely, it might be low for containerization, indicating potential security gaps in virtual environments, such as the use of outdated container images or lack of network segmentation between containers.

High availability and disaster recovery value 704 may represent the system's capability to stay operational under various conditions and its recovery strategies. In the depicted example, it may show a high value for hardware infrastructure, suggesting robust backup power supplies and failover strategies. However, it may show a lower value for containerization, indicating potential lapses in data backup or recovery procedures in virtual environments. For example, the higher value for hardware might be due to the implementation of enterprise-grade storage area network (SAN) with multi-pathing and clustering for high availability, along with comprehensive disaster recovery plans. The lower value for containerization might reflect a lack of replicated data storage or insufficiently defined recovery procedures in the containerized environment.

Storage value 706 may represent data storage efficiency, scalability, and reliability. In the depicted example, this high value with respect to hardware might indicate large, efficient storage solutions, while a lower containerization value may point towards insufficient storage allocation in virtual environments. For example, the higher value in hardware may indicate utilization of NVMe storage for high-speed data access, while a lower containerization value may highlight issues such as inadequate volume provisioning or lack of storage-class memory integration in the virtualized environment.

Networking value 708 may represent connectivity, bandwidth, and latency aspects. In the depicted example, a low value for both hardware and containerization might suggest potential bottlenecks or connectivity issues in the system. For example, low values in both hardware and containerization might reflect problems such as network congestion, inefficient load balancing solutions, or inadequate failover paths. Specific technical challenges might include improper virtual local area network (VLAN) configuration or inefficient use of software-defined wide area network (SD-WAN) technology.

Incident response value 710 may represent the system's response time and efficiency during unexpected events or breaches. In the depicted example, a lower value in hardware might point to slower physical response times, whereas a higher value in containerization might indicate efficient virtual incident handling processes. For example, a lower value in hardware might point to older, slower monitoring tools, whereas a higher value in containerization might reflect the integration of modern incident management platforms, which may enable quicker response and automated remediation workflows.

Deployment value 712 may represent the efficiency, speed, and reliability of deploying new features, patches, or entire applications. In the depicted example, a high value for both hardware and containerization may indicate a streamlined, efficient deployment process across both physical and virtual environments. For example, high values in both hardware and containerization might indicate a streamlined process for continuous integration/continuous delivery, infrastructure as code, and managing container orchestration system packages. This synergy between physical infrastructure and virtualization layers would suggest a mature, efficient deployment mechanism.

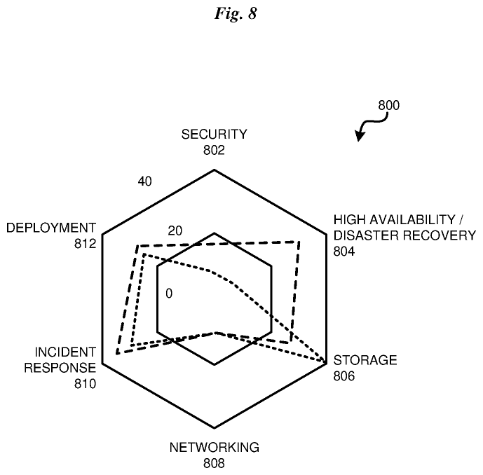

With reference to FIG. 8, this figure depicts an example site reliability engineering maturity assessment report 800 in accordance with an illustrative embodiment. The example site reliability engineering maturity assessment report of FIG. 8 may be generated using site reliability engineering maturity engine 200 of FIG. 1.

Similar to FIG. 7, site reliability engineering maturity assessment report 800 may comprise security value 802, high availability and disaster recovery value 804, storage value 806, networking value 808, incident response value 810, and deployment value 812. It is to be understood that a site reliability engineering maturity assessment report may comprise additional, fewer, or different tenets or data than what is shown in the illustrative embodiment. Moreover, although the values are depicted in a range between 0 and 40, any other range may be used depending on the particular use or application.

In contrast to site reliability engineering maturity assessment report 700 of FIG. 7. site reliability engineering maturity assessment report 800 may include a low security value in hardware. This could be due to a lack of certain physical security measures, such as absence of secure booting. BIOS-level malware checks, or limited intrusion prevention systems at the gateway level, among other factors. Such a configuration might suggest a more open system, possibly suitable for development environments or applications with lesser security concerns, rather than critical systems dealing with sensitive data.

Moreover, site reliability engineering maturity assessment report 800 may include a high storage value in containerization, indicating advanced storage capabilities in the virtualized environment. This could be due to the adoption of state-of-the-art container-native storage solutions, dynamically provisioned persistent volumes, or container storage interfaces (CSI) that integrate seamlessly with cloud storage providers. Such capabilities may be helpful for data-intensive applications, especially those requiring rapid scalability and on-the-fly storage modifications, like big data processing or video streaming platforms.

Additionally, site reliability engineering maturity assessment report 800 may include a high incident response value in hardware, indicating that the underlying physical infrastructure is geared up for quick and efficient responses to anomalies. This could be attributed to dedicated hardware accelerators for anomaly detection, advanced logging systems with high-speed storage, or tight integration with incident management tools at the hardware level. For applications demanding swift incident resolutions, like financial systems or real-time communication platforms, such an environment could be helpful.

These differences in assessments indicate that each system associated with site reliability engineering maturity assessment reports 700 and 800 may be better suited for a particular application. For instance, an application may be currently running on a cloud provider associated with site reliability engineering maturity assessment report 700. However, if the application's site reliability engineering maturity assessment report indicates a high need for storage due a recent change (e.g., due to a surge in user data or a change in data processing mechanisms), the cloud provider or on-premise infrastructure associated with site reliability engineering maturity assessment report 800 may be selected for migration of a workload associated with that application, due to that report's depicted high storage value in both hardware and containerization, as opposed to a low value in containerization as shown in FIG. 7.

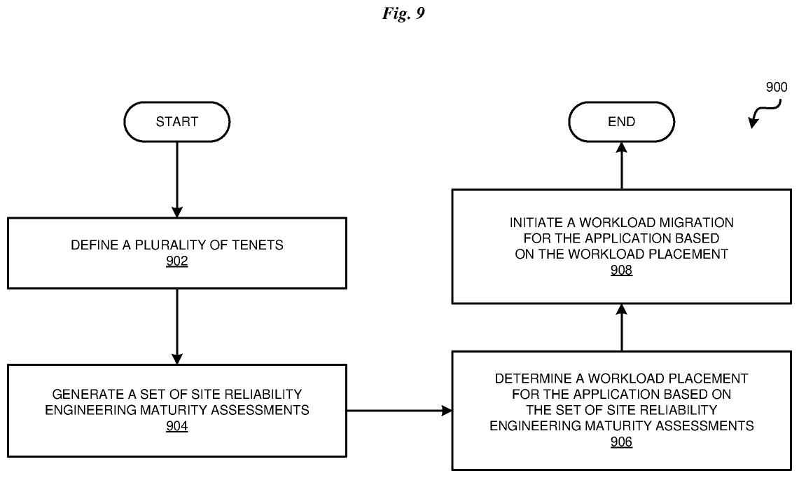

With reference to FIG. 9, this figure depicts a block diagram of an example process for site reliability engineering maturity assessment and workload management in accordance with an illustrative embodiment 900. The example block diagram of FIG. 7 may be implemented using site reliability engineering maturity engine 200 of FIG. 1.

In the illustrative embodiment, at block 902, the process defines a plurality of tenets. In some embodiments, each tenet within this plurality may represent a principle of site reliability engineering. At block 904, the process generates a set of site reliability engineering maturity assessments. In some embodiments, the process generates a first site reliability engineering maturity assessment for a first hybrid cloud component, a second site reliability engineering maturity assessment for a second hybrid cloud component, and a third assessment for an application. At block 906, the process determines a workload placement for the application based on the set of site reliability engineering maturity assessments. In some embodiments, this determination may be based on the first, second, and third site reliability engineering maturity assessments. At block 908, the process may initiate a workload migration for the application, based on the previously determined workload placement. It is to be understood that steps may be skipped, modified, or repeated in the illustrative embodiment. Moreover, the order of the blocks shown is not intended to require the blocks to be performed in the order shown, or any particular order.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (Saas) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
defining, by a site reliability engineering maturity engine, a plurality of tenets, a tenet in the plurality of tenets representing a principle of site reliability engineering;
generating, by the site reliability engineering maturity engine for the plurality of tenets, a first site reliability engineering maturity assessment for a first hybrid cloud component, a second site reliability engineering maturity assessment for a second hybrid cloud component, and a third site reliability engineering maturity assessment for an application;
determining, by the site reliability engineering maturity engine, a workload placement for the application based on the first, second, and third site reliability engineering maturity assessments; and
initiating, by the site reliability engineering maturity engine, a workload migration for the application based on the workload placement.

2. The method of claim 1, wherein the plurality of tenets includes at least one of scaling operations with load, capping operational load, overflow handling, service level agreements, operational readiness reviews, error budgeting, observability, end-user alerts handling, and blameless post-mortems.

3. The method of claim 1, wherein defining a plurality of tenets further comprises:
defining a plurality of tenet dimensions associated with the plurality of tenets.

4. The method of claim 3, wherein the plurality of tenet dimensions includes at least one of security, high availability, disaster recovery, storage, networking, incident response, and deployment.

5. The method of claim 3, wherein generating a site reliability engineering maturity assessment further comprises:
assigning a value for a tenet dimension in the plurality of tenet dimensions; and
assigning a weight for the tenet dimension in the plurality of tenet dimensions.

6. The method of claim 1, wherein determining the workload placement for the application further comprises:
computing a first difference between the first site reliability engineering maturity assessment for the first hybrid cloud component and the third site reliability engineering maturity assessment for the application;
computing a second difference between the second site reliability engineering maturity assessment for the second hybrid cloud component and the third site reliability engineering maturity assessment for the application; and
determining the workload placement based on the first difference and the second difference.

7. The method of claim 6, wherein the first difference and the second difference are computed as a difference between a value associated with a tenet in the plurality of tenets scaled by a weight associated with the tenet.

8. The method of claim 1, further comprising:
generating a report for at least one of the first, second, and third site reliability engineering maturity assessments.

9. The method of claim 1, wherein the first, second, and third site reliability engineering maturity assessments are generated based on a trigger event associated with at least one of the first hybrid cloud component, the second hybrid cloud component, and the application.

10. A computer program product comprising one or more computer readable storage media, and program instructions collectively stored on the one or more computer readable storage media, the program instructions executable by a processor to cause the processor to perform operations comprising:
defining, by a site reliability engineering maturity engine, a plurality of tenets, a tenet in the plurality of tenets representing a principle of site reliability engineering;
generating, by the site reliability engineering maturity engine for the plurality of tenets, a first site reliability engineering maturity assessment for a first hybrid cloud component, a second site reliability engineering maturity assessment for a second hybrid cloud component, and a third site reliability engineering maturity assessment for an application;
determining, by the site reliability engineering maturity engine, a workload placement for the application based on the first, second, and third site reliability engineering maturity assessments; and
initiating, by the site reliability engineering maturity engine, a workload migration for the application based on the workload placement.

11. The computer program product of claim 10, wherein defining a plurality of tenets further comprises:
defining a plurality of tenet dimensions associated with the plurality of tenets.

12. The computer program product of claim 11, wherein generating a site reliability engineering maturity assessment further comprises:
assigning a value for a tenet dimension in the plurality of tenet dimensions; and
assigning a weight for the tenet dimension in the plurality of tenet dimensions.

13. The computer program product of claim 10, wherein determining the workload placement for the application further comprises:
computing a first difference between the first site reliability engineering maturity assessment for the first hybrid cloud component and the third site reliability engineering maturity assessment for the application
computing a second difference between the second site reliability engineering maturity assessment for the second hybrid cloud component and the third site reliability engineering maturity assessment for the application; and
determining the workload placement based on the first difference and the second difference,
wherein the first difference and the second difference are computed as a difference between a value associated with a tenet in the plurality of tenets scaled by a weight associated with the tenet.

14. The computer program product of claim 10, further comprising:
generating a report for at least one of the first, second, and third site reliability engineering maturity assessments.

15. The computer program product of claim 10, wherein the first, second, and third site reliability engineering maturity assessments are generated based on a trigger event associated with at least one of the first hybrid cloud component, the second hybrid cloud component, and the application.

16. A computer system comprising a processor and one or more computer readable storage media, and program instructions collectively stored on the one or more computer readable storage media, the program instructions executable by the processor to cause the processor to perform operations comprising:
defining, by a site reliability engineering maturity engine, a plurality of tenets, a tenet in the plurality of tenets representing a principle of site reliability engineering;
generating, by the site reliability engineering maturity engine for the plurality of tenets, a first site reliability engineering maturity assessment for a first hybrid cloud component, a second site reliability engineering maturity assessment for a second hybrid cloud component, and a third site reliability engineering maturity assessment for an application;
determining, by the site reliability engineering maturity engine, a workload placement for the application based on the first, second, and third site reliability engineering maturity assessments; and
initiating, by the site reliability engineering maturity engine, a workload migration for the application based on the workload placement.

17. The computer system of claim 16, wherein defining a plurality of tenets further comprises:
defining a plurality of tenet dimensions associated with the plurality of tenets.

18. The computer system of claim 17, wherein generating a site reliability engineering maturity assessment further comprises:
assigning a value for a tenet dimension in the plurality of tenet dimensions; and
assigning a weight for the tenet dimension in the plurality of tenet dimensions.

19. The computer system of claim 16, wherein determining the workload placement for the application further comprises:
computing a first difference between the first site reliability engineering maturity assessment for the first hybrid cloud component and the third site reliability engineering maturity assessment for the application
computing a second difference between the second site reliability engineering maturity assessment for the second hybrid cloud component and the third site reliability engineering maturity assessment for the application; and
determining the workload placement based on the first difference and the second difference,
wherein the first difference and the second difference are computed as a difference between a value associated with a tenet in the plurality of tenets scaled by a weight associated with the tenet.

20. The computer system of claim 16, further comprising:
generating a report for at least one of the first, second, and third site reliability engineering maturity assessments.
